(19) United States
(12) Patent Application Publication
(10) Pub. No.: US 2003/0182216 A1
(43) Pub. Date: Sep. 25, 2003

(54) Resource recovery and recycling system and method

(76) Inventors: Dennis M. Baca, Gainesville, VA (US); Michael J. Fanning, Silver Spring, MD (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,534

(22) PCT Filed: Sep. 6, 2001
(86) PCT No.: PCT/US01/27504

(51) Int. Cl. G06F 17/60

(52) U.S. Cl. 705/35

(57) ABSTRACT

A method for recovery of resources by retrieving goods with a Postal delivery vehicle after the Postal delivery vehicle has made a delivery. The method also includes taking the retrieved goods to a central facility (104), inspecting the retrieved goods (105), sorting the goods into categorized groups (106), and diverting the categorized goods to carry out processes indicative of each category (107). In another aspect, the invention may include a system for delivering goods to a processing center. The system may comprise a location for depositing goods to be picked recycled, a Postal delivery vehicle has delivered mail, the Postal vehicle picks up goods from the location for depositing goods and delivers the goods to the processing center.

### CROSS REFERENCE TO RELATED APPLICATIONS

This application claims the benefit under 35 U.S.C. § 119 of provisional application No. 60/230,794 filed Sep. 7, 2000, titled Resource Recovery and Recycling System and Method, the full contents of which are relied on and incorporated herein.

### DESCRIPTION OF THE INVENTION

Field of the Invention

This invention relates to systems and methods for recovery and recycling of resources, such as surplus, obsolete, or unwanted electronics goods.

2. Background of the Invention

Two seemingly mutually exclusive events can be associated to create a process which yields unexpected benefits.

It has been observed that Postal delivery vehicles after delivering mail return to Postal distribution centers empty or nearly empty.

It has been further observed that with the rapid advance of electronic technology, the number of electronic components such as computers, computer monitors, television sets, printers, and the like, rendered obsolescent has also expanded. Generally, such obsolete or surplus hardware is simply discarded, often ending up in landfills. This practice results in a number of undesirable consequences. First, many electronic hardware items contain hazardous materials which ultimately leak out creating pollution issues. Next, present day electronics items are fabricated with valuable materials, such as gold, silver and other precious metals. There is but a finite supply of these materials on the earth. Relegating them to landfills will only heighten their scarcity, ultimately raising their cost, which eventually is passed on to consumers.

While recycling and recovery are known, they are practiced to a limited extent, at least in the United States.

Accordingly, encouraging the return of unwanted or unneeded electronic items for recycling has numerous favorable social, ecological and economic benefits.

Many consumers are favorably disposed towards the concept of recycling, but frequently complain that there are few opportunities to engage in recycling, as opposed to conventional, often more expedient disposal, as part of household or business trash and garbage.

A method and system for providing opportunities to recycle household goods is desired.

It is to be understood that both the foregoing general description and the following detailed description are exemplary and explanatory only and are not restrictive of the invention, as claimed.

### SUMMARY OF THE INVENTION

In accordance with the invention, methods and systems for recovery of resources by retrieving goods with a Postal delivery vehicle after the Postal delivery vehicle has made a delivery are provided. The methods may also include taking the retrieved goods to a central facility, inspecting the retrieved goods, sorting the goods into categorized groups, and diverting the categorized goods to carry out processes indicative of each category. In another aspect, the invention may include a system for delivering goods to a processing center. The system may comprise one or more locations for depositing goods to be picked and recycled, delivery vehicles, and processing centers, wherein after delivery vehicles have made a delivery, the vehicles pick up goods from the location for depositing goods and delivers the goods to processing centers.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is a flow chart of a method for recycling goods;

FIG. 2 shows an exemplary Postal delivery vehicle picking up goods and delivering them to a central facility.

### DESCRIPTION OF THE EMBODIMENTS

Reference will now be made in detail to exemplary embodiment of the invention, an example of which is illustrated in the accompanying drawings. Wherever possible, the same reference numbers will be used throughout the drawings to refer to the same or like parts.

Reference will now be made in detail to the present preferred embodiment of the invention.

System and methods for providing a comprehensive approach to recovery and recycling of unwanted or surplus goods, such as obsolete electronics and computer hardware, include the ability to utilize excess space capacity in United States Postal Service (“USPS”) delivery vehicles. As used herein, the term “recycling” is intended to include, but not be limited to, conventional recycling, reuse, remanufacturing, recovery of materials and components, resale, demanufacturing and disposal. Frequently, upon completing daily deliveries to homes and businesses, USPS vans and trucks return to Postal distribution centers empty, or nearly so. The process disclosed herein facilitates the ability for Postal patrons, businesses as well as residential, to recycle their unwanted or surplus items, such as electronics equipment, and at the same time use surplus capacity on Postal delivery vehicles.

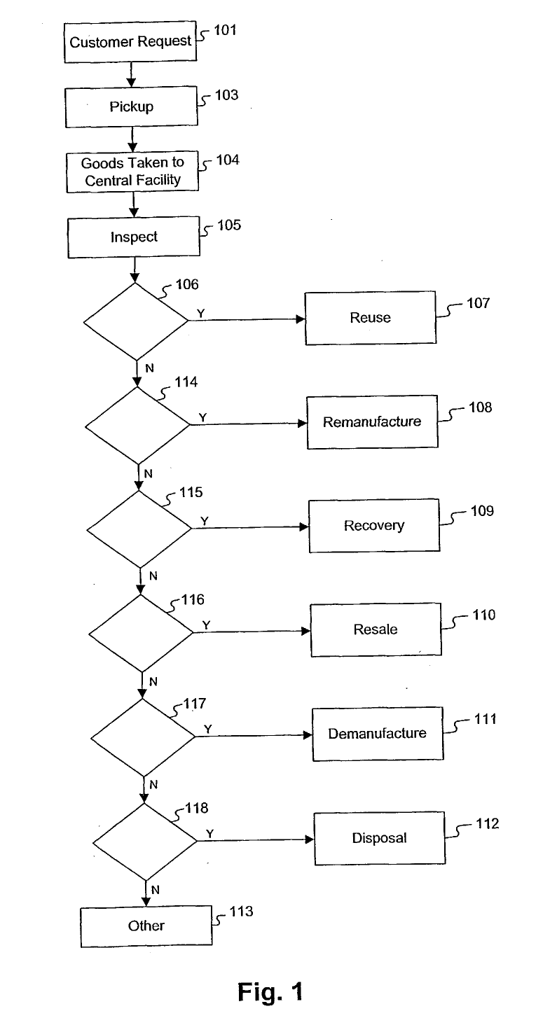

The process, shown schematically in FIG. 1, involves the following steps, some of which are optional and need not always be practiced when practicing the invention. At the first step 101, which is an optional step, the customer pre-arranges for retrieval of the goods by making a request for retrieval using a least one of the following modes of communication: telephone, email, facsimile, and regular mail. In the next step 103, the unwanted or surplus goods are retrieved by a delivery vehicle 115 after the delivery vehicle has made a delivery. The goods are taken to a central facility 104. Once at the central facility, the goods are inspected and sorted 105. The sorting involves at least one step. The steps may be done in any order. Each good may be sorted individually or the goods may be sorted by lot.

In step 106 it is determined if the goods should be reused. Such reuse may include donating the goods to schools, private charities, to schools, public agencies, assistance and welfare programs, and the like. If the answer to whether the goods should be reused is yes, then the goods are grouped to be reused 107. If the answer is no, then the goods are evaluated in another step. In step 114 it is determined if the goods should be remanufactured. If the answer is yes, then the goods are grouped to be remanufactured 108. If the answer is no, then the goods are evaluated in another step. In step 115 it is determined if the goods should be recovered. If the answer is yes, then the goods are grouped to be recovered 109. If the answer is no, then the goods are evaluated in another step. In step 116 it is determined if the goods should be resold. If the answer is yes, then the goods are grouped to be resold 110. If the answer is no, then the goods are evaluated in another step. In step 117 it is determined if the goods should be demanufactured. If the answer is yes, then the goods are grouped to be demanufactured 111. If the answer is no, then the goods are evaluated in another step. In step 118 it is determined if the goods should be disposed of. If the answer is yes, then the goods are grouped to be disposed 112. If the answer is no, then the goods are evaluated in another step. The remainder of the goods (if any) are grouped in an other category.

The goods may be diverted to separate entities to carry out process indicative of each category 107-113, or further processing or some of the further processing may be done on site.

In one embodiment, a patron will pay for shipping costs, ideally at a reduced or “green” rate, by affixing the appropriate amount of postage, either by conventional or special stamps, a prepaid mailing label, coupon, or like voucher. Optionally, the patron may be billed after a pickup has been made.

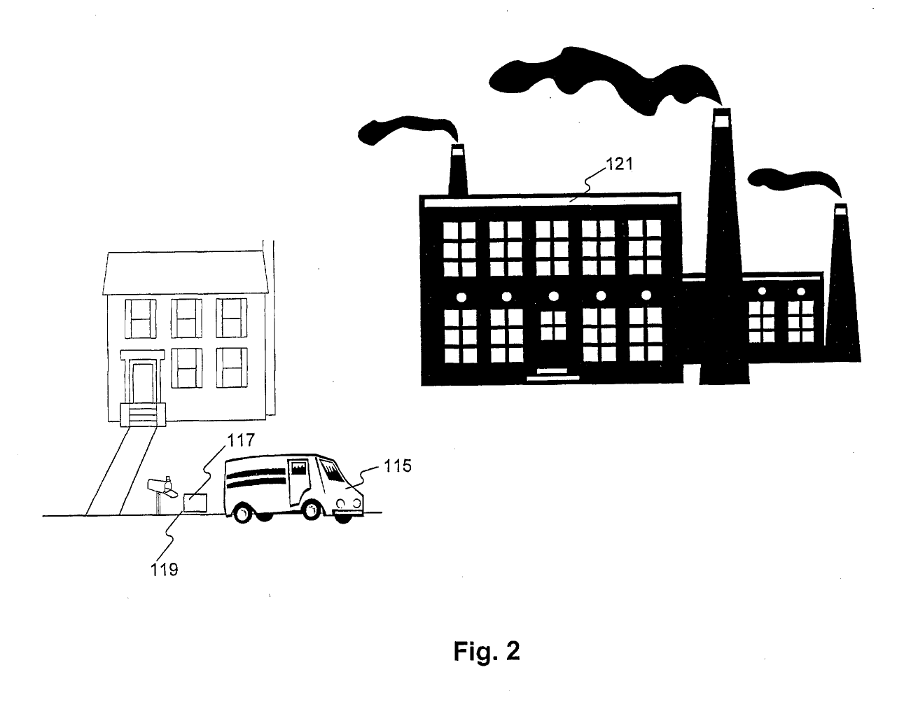

FIG. 2 shows an exemplary Postal vehicle 115 stopped and ready to pickup a good 117. The good 117 has been deposited at a pickup site 119. In FIG. 2 the pickup site is near a residence, but the pickup site is not limited to what is shown in FIG. 2. The pickup site could be at any predetermined area, such as, near or at places of business, deposit boxes, near or at mail boxes, at Post Offices, or at other suitable places. Such a pickup may be accomplished as part of the routine mail delivery process; namely, after delivering the mail to a given address, the Postal carrier will pick up any such items that are left out. Alternatively, appointments for pick-up may be made in person, say during a visit to a Post Office or recycling center, or by phone, fax, regular mail or e-mail, in which case a designated Postal carrier for a particular neighborhood will make all required pick-ups before returning to the Postal distribution center or to a recycling site 121.

Disposition of unmarked or surplus items, such as electronic equipment, provides environmentally and economically sensible disposition options for such equipment, including (but potentially not limited to): desktop computers; laptop computers; network servers; minicomputers; mainframe computers; printers; monitors; facsimile machines; copiers; telecommunications equipment; televisions; VCRs; electronic laboratory equipment and instrumentation; computer-related hardware (cabling, etc.).

One benefit is that it provides guaranteed destruction of sensitive or copyrighted software and hardware.

It also provides flexible and cost-effective pickup and transportation options for client generators.

Finally, it provides generators with binding transfer of ownership and the assurance that surplus or unmarked equipment will be handled in full compliance with all applicable federal and state laws and regulations, and elimination of potential liability for otherwise improper or illegal disposition of unwanted or surplus items.

Triage and remarketing of surplus goods, such as electronic equipment, includes sorting incoming equipment into group lots to maximize their value in secondary markets.

Limited testing of incoming equipment may also be conducted to maximize its value in secondary markets.

Hard drives and other storage devices may be erased and wiped clean of confidential or copyrighted software and/or data.

Relationships with a variety of markets for surplus equipment may be identified and established. These will include, but may not be limited to: direct donation outlets; third party donation outlets; brokers; end users of used electronic equipment; and demanufacturers.

In the case of U.S. Government generators, implementation of an organized program to donate a proportion of used equipment to schools and potentially to other charitable organizations fulfills the mandate of Executive Order 12999.

The balance of used equipment may be marketed (by auction or direct sale) in a manner that seeks to optimize economic returns while meeting environmental and social goals established by management.

Recycling and sale of recovered commodities is achieved for equipment with little or no value, in whole form, in secondary markets, but which possess positive revenue potential for their commodity value, or which will cost less to recycle for commodity value than to dispose of.

Items may be processed in-house or through third parties to shred equipment, recover, and market primary commodities (primarily metals and potentially some plastics).

For equipment with greater cost to recycle than to dispose, disposal is an option. Identifying the most cost effective disposal outlets will provide assurances of environmentally acceptable disposal and transfer of liability.

While this document describes the delivery vehicle as a Postal Service vehicle, the principles of this invention are not limited to Postal Service vehicles. A wide variety of delivery vehicles may be used. For example, package delivery services vehicles and other vehicles that make deliveries and return empty or nearly so may be used.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for recovery of resources, comprising the steps of:
retrieving goods by means of a delivery vehicle after the delivery vehicle has made a delivery;
taking the retrieved goods to a central facility;
inspecting the retrieved goods;
sorting the goods into groups categorized according to at least the following goods: reuse, remanufacturing, recovery, resale, demanufacturing and disposal; and
diverting the categorized goods to separate entities who will carry out processes indicative of each category.

2. A method for recovery of resources, comprising:
retrieving goods with a delivery vehicle after the delivery vehicle has made a delivery;
taking the retrieved goods to a central facility;
inspecting the retrieved goods;
sorting the goods into categorized groups; and
diverting the categorized goods for purposes of carrying out processes indicative of each category.

3. The method of claim 2, wherein the delivery vehicle is a Postal Service vehicle.

4. The method of claim 2, wherein the goods comprise electronic equipment.

5. The method of claim 2, further comprising charging for retrieval of the goods.

6. The method of claim 5, further comprising paying for retrieval of the goods by associating postage with the goods.

7. The method of claim 5, further comprising charging a special green postage rate for at least retrieval of the goods.

8. The method of claim 2, further comprising billing for at least the cost of the removal of the goods after the retrieval of the goods.

9. The method of claim 2, further comprising pre-arranging for retrieval of the goods by using at least one of the following modes of communication; telephone call, email, facsimile, and mail.

10. The method of claim 2, further comprising recycling at least a portion of the goods.

11. The method of claim 2, further comprising erasing items stored on memory devices associated with the goods.

12. The method of claim 2, further comprising testing the goods to determine operability of the goods.

13. The method of claim 2, further comprising establishing relationships with other parties to assist in recycling the goods.

14. The method of claim 2, further comprising donating the goods.

15. The method of claim 2, wherein the delivery vehicle has a delivery route, and the goods are picked up at least one location along the delivery route.

16. A system for delivering goods to a processing center comprising:
a location for depositing goods to be picked recycled;
a delivery vehicle; and
a processing center,
wherein after the delivery vehicle has delivered mail, the delivery vehicle picks up goods from the location for depositing goods and delivers the goods to the processing center.

17. The system of claim 16, wherein the delivery vehicle is a Postal Service vehicle.

18. A method for recovery of resources, comprising the steps of:
retrieving goods by means of a delivery vehicle after the delivery vehicle has made a delivery;
taking the retrieved goods to a central facility;
inspecting the retrieved goods;
sorting the goods into groups categorized according to at least the following categories: reuse, remanufacturing, recovery, resale, demanufacturing and disposal; and
diverting the categorized goods to separate entities capable of carrying out processes indicative of each category.
